(19) United States
(12) Patent Application Publication
(10) Pub. No.: US 2016/0246637 A1
(43) Pub. Date: Aug. 25, 2016

(54) Determining Trustworthiness of a Virtual Machine Operating System Prior To Boot UP

(71) Applicant: MCAFEE, INC., Santa Clara, CA (US)

(72) Inventor: Jayasankar Divakarla, Bangalore, KA (IN)

(21) Appl. No.: 15/026,223

(22) PCT Filed: Nov. 15, 2013
(86) PCT No.: PCT/US2013/070367

§ 371 Date: Mar. 30, 2016

(51) Int. Cl. G06F 9/455; G06F 9/44; G06F 17/30

(52) U.S. Cl. CPC G06F 9/45558; G06F 17/30876; G06F 9/4406; G06F 2009/45575; G06F 2009/45595

(57) ABSTRACT

This disclosure relates generally to systems, apparatuses, methods, and computer readable media for intercepting a virtual machine boot process. More particularly, but not by way of limitation, this disclosure relates to systems, apparatuses, methods, and computer readable media to intercept a boot process of a virtual machine that can include intercepting a boot process of the virtual machine and calculating identifying information about the operating system. The identifying information is verified and the boot process of the virtual machine may or may not be allowed complete based upon verification of the identifying information.

### TECHNICAL FIELD

This disclosure relates generally to systems, apparatuses, methods, and computer readable media for intercepting a virtual machine boot process. More particularly, but not by way of limitation, this disclosure relates to systems, apparatuses, methods, and computer readable media to intercept a boot process of a virtual machine and allowing completion of the boot process based upon verification of identifying information.

### BACKGROUND

In computer science, “cloud computing” is a synonym for distributed computing that involves a number of computers and computer types connected through a real-time and often broad-ranging communication network, such as the Internet. In cloud computing, or colloquially “the cloud,” the load of running programs and storing resultant data is distributed across many connected computers at the same time, thus the computing resources are shared. In cloud computing, the resources are not only shared by multiple users, they may also be dynamically allocated per demand. Cloud computing is commonly used to refer to network-based services which appear to be provided by real server hardware, but in fact may be provided by virtual machines.

A virtual machine (VM) is a software implementation of a machine (i.e. a computer) that executes programs like a physical machine. A virtual machine (VM) is a software based, hypothetical computer that may be based on specifications of a hypothetical computer and emulate the computer architecture and functions of a real world computer. Virtual machines provide several advantages over real computer servers including high availability, reduced power consumption, reduced cooling costs, and savings on hardware and related maintenance. Virtual machines may also provide reduced application and operating system (OS) testing, reduced OS licensing costs, reduced backup licensing costs, and reduced antivirus costs.

However, a known issue with virtual machines is that antivirus or malware software is only invoked upon the OS in the virtual datacenter booting up and running. Thus, there is no known mechanism to ensure that the OS booting up in the virtual machine is uninfected or is otherwise compromised. Further, there is no mechanism to ensure that the virtual machine boots up only if an OS that may have been infected with malware has been patched to levels required by an Information Technology (IT) policy controlling the virtual machine. As can be appreciated, without a mechanism to attest to the trustworthiness of the OS of a virtual machine, it may be difficult for clients to move important workloads to the virtual machine, due to a potential lack of trust.

### BRIEF DESCRIPTION OF THE DRAWINGS

FIG. 1 is a simplified block diagram illustrating network architecture according to one or more disclosed embodiments;

FIG. 2 simplified block diagram illustrating a computer server adapted to run one or more virtual machines according to one or more disclosed embodiments;

FIG. 3 illustrates a simplified block diagram a computer server adapted to run one or more virtual machines coupled to a back-end server via one or more computer networks according to one or more disclosed embodiments;

FIG. 4 illustrates a flow diagram showing a method for intercepting a virtual machine boot process and allowing completion of the boot process based upon verification of identifying information; and

FIG. 5 illustrates a flow diagram showing an exemplary method for invoking and controlling a provisioning utility.

### DETAILED DESCRIPTION

Disclosed are systems, apparatuses, methods, and computer readable media for intercepting a virtual machine boot process and allowing completion of the boot process based upon verification of identifying information. According to some embodiments, a boot process of a virtual machine is intercepted and identifying information about an operating system of the virtual machine is calculated. The identifying information is verified and the boot process of the virtual machine may or may not be allowed to complete based upon verification of the identifying information.

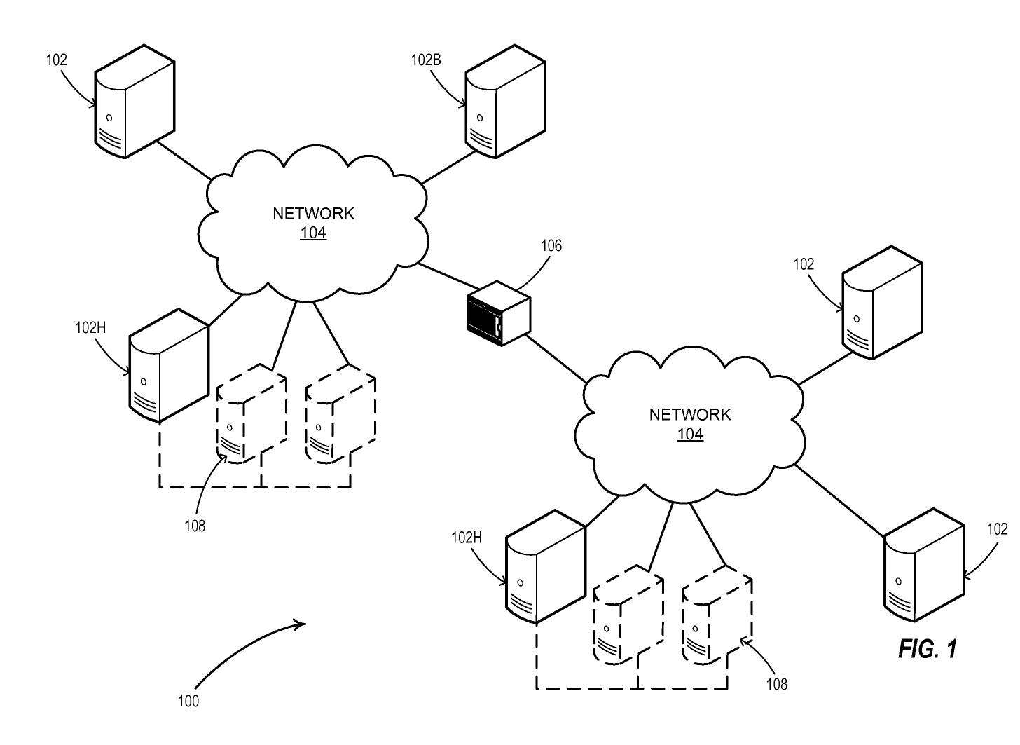

An issue common to prior art virtual machines is that antivirus or malware software is invoked upon an operating system in a virtual machine booting up and running. A potential solution to this issue is illustrated in the Figures. As illustrated in FIG. 1, there is shown generally at 100, an embodiment of a system for intercepting a virtual machine boot process. In a general embodiment, the system 100 is adapted to intercept a boot process of a virtual machine, calculate identifying information about an operating system of the virtual machine, verify the identifying information; and allow completion of the boot process of the virtual machine based upon verification of the identifying information, thoroughly discussed hereinafter.

In a general embodiment, the system 100 can include at least one computer server 102 connected to one or more computer networks 104. The computer networks 104 may include many different types of computer networks available today, such as the Internet, a corporate network, or a Local Area Network (LAN). Each of these networks can contain wired or wireless devices and operate using any number of network protocols (e.g., TCP/IP). Networks 104 can be connected via gateways and routers (represented by 106).

One or more virtual machines 108 may be hosted on one or more computer servers 102. A server 102 on which the hypervisor 110 may run one or more virtual machines 108 may be referred to hereinafter as a host machine or host server 102H. Virtual machines 108 may be based on, or have specifications, including architecture and functionality, of real world computers, such as severs 102. It is to be understood that only two virtual machines 108 are shown in the Figures for ease discussion only, and that one or more severs 102 may be adapted to host a plurality of virtual machines 108.

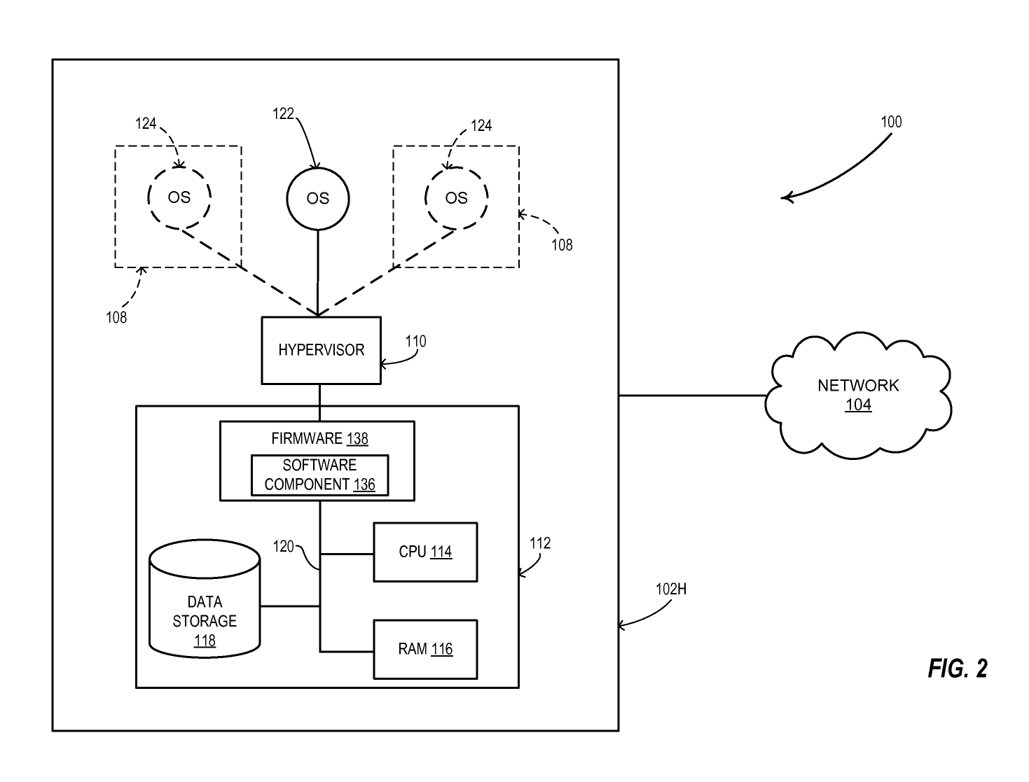

Referring to FIG. 1 and FIG. 2, one or more host servers 102H may include a virtual machine monitor or hypervisor 110 that is adapted to create and run virtual machines 108. The hypervisor 110 may include computer server software, firmware, and hardware components, shown at 112. For example, the server hardware 112 can include one or more central processing units (CPUs) 114, Random Access Memory (RAM) 116, and data storage 118, all of which can be interconnected via a system bus 120.

In the embodiment shown in FIG. 2, the hypervisor 110 can run directly on the host's hardware 112 under the control of a host operating system (OS) 122 running on the CPU 114, to manage one or more virtual operating systems (OS) 124, which may be similar or different to the host operating system 122. Thus, the virtual operating system 124 may run a level above the hypervisor 110. In alterative embodiments (not shown), the hypervisor 110 may run within the host operating system 122, where the hypervisor 110 is a distinct second software level, and the virtual operating systems 124 may run at a third level above the hardware 112. In either embodiment, the hypervisor 110 presents the virtual operating systems 124, comprising the virtual machines 108, with a virtual operating platform and manages the execution of the virtual operating systems 124. Multiple instances of a variety of virtual operating systems 124, which may be similar or different to one another, share virtualized hardware which may comprise all or determined portions of the host server's hardware 112.

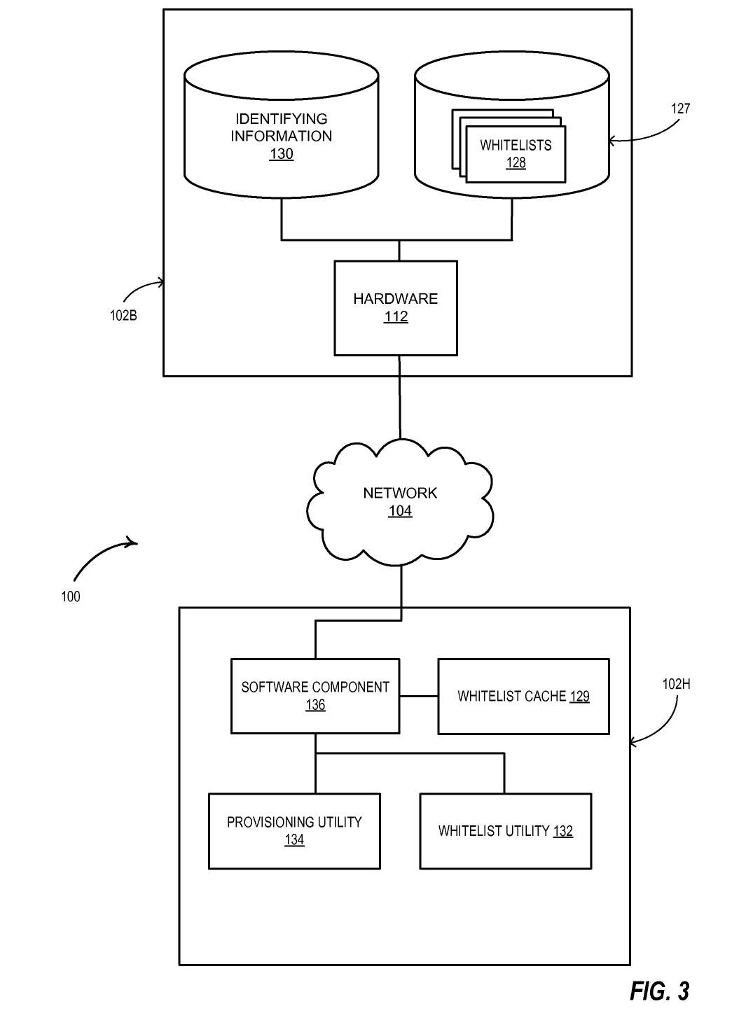

Referring to FIG. 2 and FIG. 3 of the drawings, the system 100 may include a back-end server 102B that may be connected to the host server 102H via one or more networks 104. The back-end server 102B may include a database 127 of whitelists 128. If, the back-end server 102B is not reachable by the host server 102H, one or more whitelists 128 may be stored in a whitelist cache 129, which may comprise a portion of memory 116 of the host server 102H. The back-end server 102B may also include an identifying information storage 130 for storing identifying information, such as hashes of the boot processes of one or more virtual operating systems 124.

In the embodiments, the system 100 may include a whitelisting utility 132 and a provisioning utility 134. The whitelisting utility 132 and provisioning utility 134 may each be maintained anywhere within the system 100. In an exemplary embodiment, the whitelisting and provisioning utilities 132, 134 are maintained on a server 102 such as the host server 102H.

In the whitelisting utility 132, trusted virtual operating systems 124 are automatically inventoried and file hashes generated. Exemplary hash functions used to generate the hashes of the virtual operating systems 124 may include cryptographic hash functions such as MD5, SHA-1, and other suitable hash functions. Components involved in a boot process of the virtual operating system 124 that may be hashed can include a master boot record (MBR), GRUB entries, operating system files, devices drivers, and other appropriate components of the boot process.

The provisioning utility 134 adds the hashes from trusted virtual operating systems 124, or software patches for a virtual operating system, to a new whitelist 128 to be added to the whitelist database 127. Where one or more the virtual machines 108 are running on a host server 102H, each virtual machine 108 that may be running the same virtual operating system 124 version and/or patch version is selected. The back-end server 102B is then updated with information to map each selected virtual machine 108 with the new whitelist 128. As whitelists 128 are created in a controlled environment, all whitelisted virtual operating systems 124 are considered trusted. Thus, in the embodiments, one or more whitelists 128 may be generated for each virtual operating system 124, and thus virtual machine 108, and stored in the whitelist database 127.

As shown in FIG. 2 and FIG. 3, in some embodiments, at least a portion of the system 100 may comprise a set of computer instructions, such as a software component 136. The software component 136 is configured to intercept a boot process of one or more virtual operating systems 124. The software component 136 may comprise a plug-in, or similar software extension, comprising a set of computer instructions that may be written into firmware 138, such as Unified Extensible Firmware Interface (UEFI) to define a software interface between any real or virtual operating systems 122, 124 and the firmware 138.

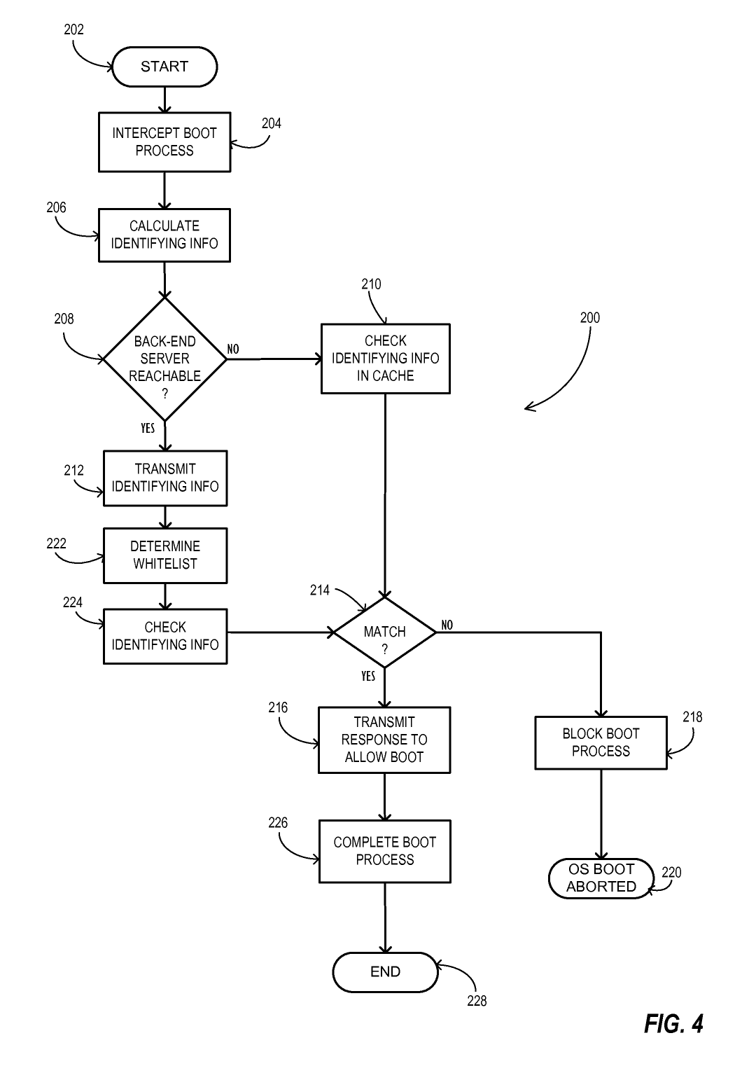

An exemplary embodiment of a method for intercepting a boot process of a virtual machine, calculate identifying information about an operating system of the virtual machine, verify the identifying information, and allowing completion of the boot process of the virtual machine based upon verification of the identifying information is shown generally at 200 in FIG. 4. As an option, the method 200 may be carried out in the context of the architecture and environment of the Figures, and particularly to FIGS. 1-3 of the Figures. However, the method 200 may be carried out in any desired environment.

Optionally, the method 200 may take the form of computer instructions, such as the software component 136 discussed above. The method 200 commences in operation 202. In operation 204 a boot process of an operating system is intercepted. The intercepted operating system boot process may comprise the boot process for a virtual operating system 124 of a virtual machine 108. In operation 206, the method 200 calculates identifying information about the operating system 124. Identifying information may be calculated using the previously discussed hash functions. Components involved in the boot process of the operating system 124 that may be hashed can include a master boot record (MBR), GRUB entries, operating system files, devices drivers, and other appropriate components of the boot process.

In operation 208 it is determined if the back-end server 102B is reachable by the host server 102H. Due to various circumstances, such as network errors, the back-end server 102B may not reachable by the host 102H. If the back-end server 102B is not reachable, the method 200 continues to operation 210, and if the back-end server 102B is reachable, the method 200 continues to operation 212. In operation 210, the identifying information may be transmitted to the whitelist cache 129. The identifying information is compared to one or more whitelists stored in the whitelist cache 129, to determine if the identifying information is matched, in operation 214. If the identifying information is matched to the one or more whitelists stored in the whitelist cache 129, the method 200 continues to operation 216.

If the identifying information is not matched to one or more whitelists stored in the whitelist cache 129, in operation 214, the method 200 continues to operation 218. In operation 218, the identifying information is not matched to one or more whitelists stored in the whitelist cache 129 and is considered not trusted. The boot process is aborted in operation 220. Since the identifying information does not match one or more whitelists stored in the whitelist cache 129, the virtual operating system 124 may have been subjected to a malicious attack by malware. Thus, the method 200 prevents the virtual operating system 124 and virtual machine 108 from being infected by malware, by aborting the boot process.

Returning to operation 208, if the back-end server 102B is reachable, the method 200 continues to operation 212, where the identifying information is transmitted to the back-end server 102B. In operation 222, the provisioning utility 134 is invoked to determine a whitelist 128 to be used for checking the identifying information, based on the particular virtual operating system 124. Depending upon the particular virtual operating system 124 being booted, the provisioning utility 134 selects a whitelist 128 from the database 127, in operation 224. In operation 224, the whitelisting utility 132 is invoked to compare identifying information received from the provisioning utility 134 to the whitelist 128 selected by the provisioning utility 134. In operating 214, if the identifying information is not matched to the selected whitelist 128, then the method 200 continues to operation 218, where the identifying information is considered not-trusted. The method 200 then continues to operation 220, where boot process is aborted. Since the identifying information does not match the selected whitelist 128, the virtual operating system 124 may have been subject to an attack by malware. Thus, the method 200 prevents the virtual operating system 124 from booting and becoming infected.

If, in operation 214, the identifying information is matched to the selected whitelist 128, the method 200 continues to operation 216. The identifying information matches the whitelist and the virtual operating system 124 has not been subject to an attack by malware and is verified as trusted. The method 200 then continues to operation 216, where the back-end server 102B sends a response to the host server 102H to allow the boot process to complete. The method then ends in operation 228.

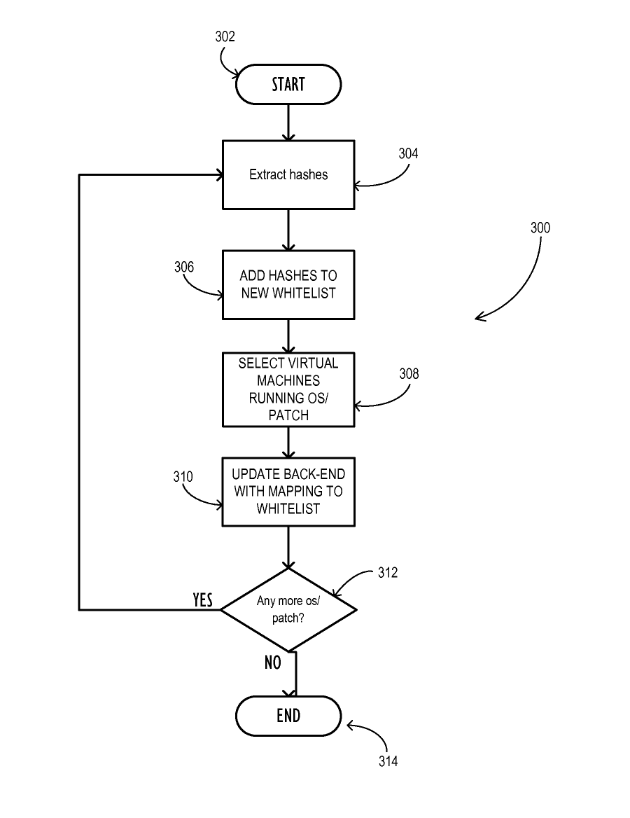

An exemplary embodiment of a method for invoking and controlling the provisioning utility 134 is shown generally at 300 in FIG. 5. As an option, the method 300 may be carried out in the context of the architecture and environment of the Figures, and particularly to FIGS. 1-3 of the Figures. However, the method 300 may be carried out in any desired environment.

The method 300 commences in operation 302. In operation 304 hashes of the components of an operating system boot process are extracted. Hashes, such as those previously discussed, may be extracted from a gold image of an operating system, such as a virtual operating system 124, or a software patch for an operating system. In operation 306, the extracted hashes are added as a new whitelist 128 to the whitelist database 127 on the back-end server 102B.

The method 300 continues in operation 308, where from the virtual machines 108 on the host server 102H, each virtual machine 108 that may be running the same operating system 124 version and/or patch version is selected. The back-end server 102B is then updated with information to map each selected virtual machine 108 with the new whitelist 128, in operation 310. In operation 312, it is determined if any additional virtual operating systems 124 and/or patch versions need to be added to the whitelist database 127. If additional virtual operating systems 124 and/or patch versions need to be added to the whitelist database 127, the method 300 returns to operation 304, otherwise the method 300 ends in operation 314.

### EXAMPLES

The following examples pertain to further embodiments. Example 1 is a non-transitory computer readable medium comprising computer executable instructions stored thereon that when executed cause one or more processing units to intercept a boot process of a virtual machine; calculate identifying information about an operating system of the virtual machine; verify the identifying information; and allow completion of the boot process of the virtual machine upon verification of the identifying information.

Example 2 includes the subject matter of example 1, wherein the instructions to calculate identifying information further comprise instructions to compare the identifying information to a whitelist.

Example 3 includes the subject matter of example 1 and further comprises computer executable instructions stored thereon that when executed cause the one or more processing units to transmit the identifying information to a remote computer.

Example 4 includes the subject matter of example 1, wherein the instructions to calculate identifying information further comprise instructions to generate a hash of at least a portion of the boot process.

Example 5 includes the subject matter of example 4, wherein the instructions to calculate identifying information further comprise instructions to compare the hash with a whitelist.

Example 6 is a system that comprises a virtual machine comprising one or more virtual processors adapted to run an operating system; at least one virtual memory to store non-transitory computer executable instructions, the non-transitory computer executable instructions thereon that when executed cause the virtual processor to intercept a boot process of the virtual machine; calculate identifying information about the operating system; verify the identifying information; and allow completion of the boot process of the virtual machine based upon verification of the identifying information.

Example 7 includes the subject matter of example 6, wherein the instructions to calculate identifying information further comprise instructions to generate a hash of at least a portion of the boot process of the virtual machine.

Example 8 includes the subject matter of example 7, wherein the instructions to calculate identifying information further comprise instructions to compare the hash with a whitelist to verify the hash.

Example 9 includes the subject matter of example 8, wherein the whitelist is stored in the virtual memory.

Example 10 includes the subject matter of example 6, wherein if the identifying information is verified the boot process is allowed to complete and if the identifying information not verified the boot process is terminated.

Example 11 is a system that comprises a virtual machine comprising a virtual processor adapted to run an operating system; a virtual memory adapted to store non-transitory computer executable instructions, the non-transitory computer executable instructions stored thereon that when executed cause the virtual processor to intercept a boot process of the virtual machine; calculate identifying information about the operating system; and transmit the identifying information to a remotely located server; receive a response from the server; and determine completion of the boot process based upon the response.

Example 12 includes the subject matter of example 11, wherein the instructions to calculate identifying information further comprise instructions to generate a hash of at least a selected portion of the boot process.

Example 13 includes the subject matter of example 11, wherein the instructions to determine completion of the boot process further comprise instructions to allow the boot process to complete if the response indicates the identifying information is verified, and terminate the boot process if the response indicates the identifying information.

Example 14 is a system that comprises a server including one or more processors and a memory adapted to store non-transitory computer executable instructions, the non-transitory computer executable instruction stored thereon that when executed cause the one or more processors to receive identifying information corresponding to an operating system from a virtual machine; verify whether the operating system is trusted based on the identifying information; and transmit a response to the virtual machine indicating whether the operating system is trusted.

Example 15 includes the subject matter of example 14, wherein the identifying information comprises a hash of at least a selected portion of the boot process of the virtual machine.

Example 16 includes the subject matter of example 15, wherein the instructions to verify whether the operating system is trusted further comprise instructions to compare the hash with a whitelist.

Example 17 includes the subject matter of example 16, wherein the whitelist is stored in a database on the server.

Example 18 includes the subject matter of example 17, wherein the whitelist is selected from a plurality of whitelists stored in the database.

Example 19 includes the subject matter of example 18, wherein the whitelist is determined by a version of the operating system.

Example 20 includes the subject matter of example 14, wherein the instructions to transmit a response to the virtual machine further comprise instructions to transmit a response to allow the boot process to complete if the operating system is trusted, and to transmit a response to terminate the boot process if the operating system is not trusted.

Example 21 is a method of intercepting a virtual machine boot process comprises intercepting a boot process of a virtual machine; calculating identifying information; verifying the identifying information; and allowing completion of the boot process based upon verification of the identifying information.

Example 22 includes the subject matter of example 21 and further comprises generating a hash of at least a selected portion of the boot process.

Example 23 includes the subject matter of example 22 and further comprises comparing the hash with a whitelist to verify the hash.

Example 24 includes the subject matter of example 21 and further comprises determining if the identifying information is verified; and if the identifying information is verified, then allowing the boot process to complete, and if the identifying information not verified, then terminating the boot process.

Example 25 is a system that comprises computing means to intercept a boot process of an operating system of a virtual machine; computing means to calculate identifying information about the operating system; transmitting means to transmit the identifying information to a remote server; receiving means to receive a response at the virtual machine from the remote server; and computing means to allow completion of the boot process of the virtual machine based upon the response.

Example 26 includes the subject matter of example 25, wherein the computing means to calculate identifying information further comprises computing means to generate a hash of at least a selected portion of the boot process.

Example 27 includes the subject matter of example 25, wherein the computing means to allow completion of the boot process further comprises computing means to allow the boot process to complete if the response indicates that the identifying information is verified and to terminate the boot process if the response indicates that identifying information is not verified.

Example 28 is an apparatus that comprises receiving means to receive identifying information from a virtual machine; computing means to verify the identifying information; and transmitting means to transmit a response to the virtual machine for determining completion of a boot process of the virtual machine.

Example 29 includes the subject matter of example 28, wherein the identifying information comprises a hash of at least a selected portion of the boot process of the virtual machine.

Example 30 includes the subject matter of example 29, wherein the computing means to verifying the identifying information further comprises computing means to compare the hash with a whitelist.

Example 31 includes the subject matter of example 28, wherein the transmitting means to transmit a response further comprises transmitting a response to the virtual machine allow the boot process to complete if the identifying information is verified, and transmitting a response to the virtual machine to terminate the boot process if the identifying information is not verified.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

1-25. (canceled)

26. A computer readable medium comprising computer executable instructions stored thereon that when executed cause some of the one or more processing units to:
intercept a boot process of a virtual machine;
calculate identifying information about an operating system of the virtual machine;
verify the identifying information; and
allow completion of the boot process of the virtual machine upon verification of the identifying information.

27. The computer readable medium of claim 26, wherein the instructions to calculate the identifying information further comprise instructions to compare the identifying information to a whitelist.

28. The computer readable medium of claim 26, further comprising computer executable instructions stored thereon that when executed cause the one or more processing units to:
transmit the identifying information to a remote computer.

29. The computer readable medium of claim 26, wherein the instructions to calculate the identifying information further comprise instructions to generate a hash of at least a portion of the boot process.

30. The computer readable medium of claim 29, wherein the instructions to calculate the identifying information further comprise instructions to compare the hash with a whitelist.

31. A system comprising:
one or more processors;
a memory, coupled to the one or more processors, on which are stored instructions, comprising instructions that when executed cause some of the one or more processors to:
create and run a virtual machine;
intercept a boot process of an operating system of the virtual machine;
calculate identifying information about the operating system; and
transmit the identifying information to a remotely located server to verify whether the operating system is trusted based on the identifying information;
receive a response from the server indicating whether the operating system is trusted; and
determine completion of the boot process based upon the response.

32. The system of claim 31, wherein the instructions to calculate the identifying information further comprise instructions to generate a hash of at least a selected portion of the boot process.

33. The system of claim 32, wherein the instructions to calculate the identifying information further comprise instructions to compare the hash with a whitelist to verify the hash.

34. The system of claim 31, wherein the whitelist is determined by a version of the operating system.

35. The system of claim 31, wherein the instructions to determine the completion of the boot process further comprise instructions to allow the boot process to complete if the response indicates the operating system is trusted, and terminate the boot process if the response indicates the operating system is not trusted.

36. A system comprising:
a server including one or more processors and a memory adapted to store computer executable instructions, the computer executable instructions stored thereon that when executed cause some of the one or more processors to:
receive identifying information corresponding to an operating system from a virtual machine;
verify whether the operating system is trusted based on the identifying information; and
transmit a response to the virtual machine indicating whether the operating system is trusted.

37. The system of claim 36, wherein the identifying information comprises a hash of at least a selected portion of the boot process of the virtual machine.

38. The system of claim 37, wherein the instructions to verify whether the operating system is trusted further comprise instructions to compare the hash with a whitelist.

39. The system of claim 38, wherein the whitelist is stored in a database on the server.

40. The system of claim 39, wherein the whitelist is selected from a plurality of whitelists stored in the database.

41. The system of claim 40, wherein the whitelist is determined by a version of the operating system.

42. The system of claim 36, wherein the instructions to transmit a response to the virtual machine further comprise instructions to transmit a response to allow the boot process to complete if the operating system is trusted, and to transmit a response to terminate the boot process if the operating system is not trusted.

43. A method of intercepting a virtual machine boot process comprising:
intercepting a boot process of a virtual machine;
calculating identifying information;
verifying the identifying information; and
allowing completion of the boot process based upon verification of the identifying information.

44. The method of claim 43, further comprising:
generating a hash of at least a selected portion of the boot process; and
comparing the hash with a whitelist to verify the hash.

45. The method of claim 43, further comprising:
determining if the identifying information is verified; and
if the identifying information is verified, then allowing the boot process to complete, and
if the identifying information not verified, then terminating the boot process.

46. A system comprising:
computing means to intercept a boot process of an operating system of a virtual machine;
computing means to calculate identifying information about the operating system;
transmitting means to transmit the identifying information to a remote server;
receiving means to receive a response at the virtual machine from the remote server; and
computing means to allow completion of the boot process of the virtual machine based upon the response.

47. The system of claim 46, wherein the computing means to calculate the identifying information further comprises computing means to generate a hash of at least a selected portion of the boot process.

48. The system of claim 46, wherein the computing means to allow the completion of the boot process further comprises:
computing means to allow the boot process to complete if the response indicates that the identifying information is verified and to terminate the boot process if the response indicates that identifying information is not verified.

49. An apparatus comprising:
receiving means to receive identifying information from a virtual machine;
computing means to verify the identifying information; and
transmitting means to transmit a response to the virtual machine for determining completion of a boot process of the virtual machine.

50. The apparatus of claim 49, further comprising:
wherein the identifying information comprises a hash of at least a selected portion of the boot process of the virtual machine; and
wherein the computing means to verify the identifying information further comprises computing means to compare the hash with a whitelist.
